(19) United States
(12) Patent Application Publication
(10) Pub. No.: US 2024/0345783 A1
(43) Pub. Date: Oct. 17, 2024

(54) IMAGE FORMING SYSTEM AND IMAGE FORMING METHOD

(71) Applicant: KYOCERA Document Solutions Inc., Osaka (JP)

(72) Inventors: Yosuke MORISHITA, Osaka-shi (JP); Yoshitaka KISHI, Osaka-shi (JP); Kenichi KATSURA, Osaka-shi (JP); Shinya OGAWA, Osaka-shi (JP)

(73) Assignee: KYOCERA Document Solutions Inc., Osaka (JP)

(21) Appl. No.: 18/631,838

(22) Filed: Apr. 10, 2024

(30) Foreign Application Priority Data
Apr. 11, 2023 (JP) 2023-064036

(51) Int. Cl. G06F 3/12; H04L 9/08

(52) U.S. Cl. CPC G06F 3/1236; G06F 3/1204; G06F 3/1238; G06F 3/1286; G06F 3/1292; H04L 9/0819

(57) ABSTRACT

An image forming system 100 includes a terminal 10, an image forming apparatus 20, and a network repeater 30. The image forming apparatus 20 includes a writer 24 that writes identification information of the network repeater 30 to a wireless communication tag 22. The terminal 10 includes a display device 12 that presents the identification information read from the wireless communication tag 22, a terminal's communication device 16 that is allowed to connect to and communicate with the image forming apparatus 20, and a transmitter 14 that transmits, to the image forming apparatus 20, the identification information selected by a user and an encryption key entered by the user. The image forming apparatus 20 configures a connection with the network repeater 30 based on the identification information and the encryption key transmitted from the terminal 10.

### INCORPORATION BY REFERENCE

The present application claims priority under 35 U.S.C. § 119 to Japanese Patent Application No. 2023-64036, filed on Apr. 11, 2023. The contents of this application are incorporated herein by reference in their entirety.

### BACKGROUND

The present disclosure relates to an image forming system and an image forming method.

A configuration device has been proposed to wirelessly connect an electronic device to a network using a mobile terminal with a near-field communication function.

An electronic device is configured so that a mobile terminal writes the information required for configuration to a wireless communication tag provided by the electronic device.

### SUMMARY

An image forming system according to an aspect of the present disclosure include a terminal, an image forming apparatus, and a network repeater. The terminal allows a user to use. The image forming apparatus allows the user to use. The image forming apparatus includes a wireless communication tag. The network repeater allows the image forming apparatus to connect to and communicate over a network. The network repeater includes a network repeater's communication device that transmits identification information identifying the network repeater. The image forming apparatus includes a writer that writes the identification information received to the wireless communication tag. The terminal includes a reader, a display device, a terminal's communication device, an input device, and a transmitter. The reader reads the identification information from the wireless communication tag. The display device presents the identification information read by the reader. The terminal's communication device is allowed to connect to and communicate with the image forming apparatus. The input device receives an encryption key that is information associated with the identification information and required for connection with the network repeater. The transmitter transmits, to the image forming apparatus, the identification information selected by the user from one or more pieces of identification information presented on the display device and the encryption key entered by the user. The image forming apparatus configures a connection with the network repeater based on the identification information and the encryption key transmitted from the transmitter of the terminal.

### BRIEF DESCRIPTION OF THE DRAWINGS

FIG. 1 is a block diagram that depicts a configuration of an image forming system according to an embodiment of the present disclosure.

FIG. 2 is a block diagram that depicts a configuration of an image forming system in the presence of a plurality of network repeaters.

FIG. 3 is a block diagram that depicts a configuration of an image forming system that allows users to easily make settings for communication between a terminal and an image forming apparatus on the terminal side.

FIG. 4 is a block diagram that depicts a configuration of an image forming system in the presence of a history of connections with a terminal made in the past by a network repeater.

FIG. 5 is a flow chart that depicts the overall process of an image forming system.

### DETAILED DESCRIPTION

Embodiments of the present disclosure will be described below with reference to the drawings. Note that elements which are the same or equivalent are labeled with the same reference signs in the drawings and description thereof is not repeated.

### Configuration of Image Forming System

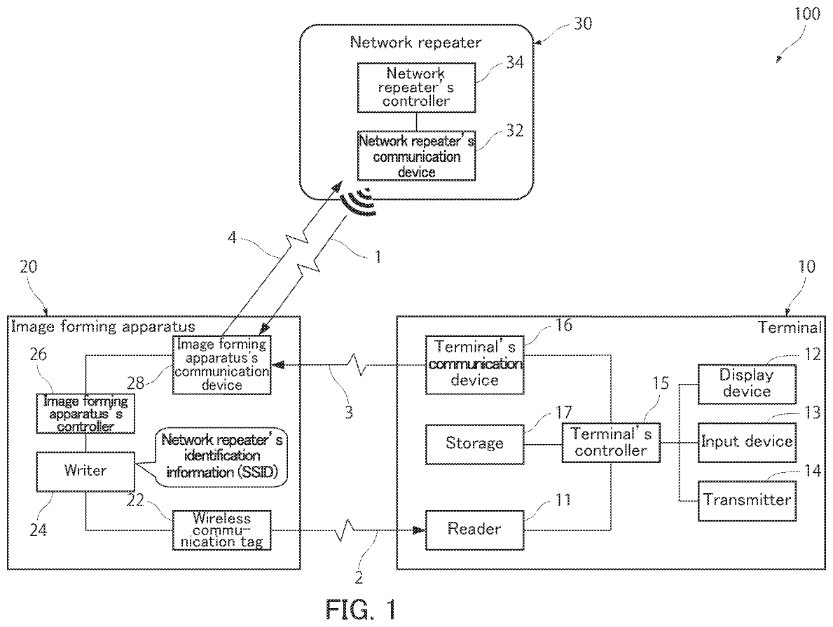

A configuration of an image forming system 100 according to an embodiment of the present disclosure will be described with reference to FIG. 1. FIG. 1 is a block diagram that depicts the configuration of the image forming system 100.

The image forming system 100 includes a terminal 10 that allows users to use an image forming apparatus 20, and a network repeater 30 that allows the image forming apparatus 20 to connect to and communicate over a network.

In the present embodiment, the terminal 10 is a smartphone. However, examples thereof may further include a tablet terminal and a personal computer (PC). Typical examples of the image forming apparatus 20 include a network printer and a multi-function peripheral (MFP). Examples of the network repeater 30 include an access point and a wireless local area network (LAN) router.

The image forming apparatus 20 is allowed to connect to and communicate over a network. Because of this, users are required to use the terminal 10 to make settings for connecting the image forming apparatus 20 to the network repeater 30. In the present embodiment, the communication between the image forming apparatus 20 and the network repeater 30 is performed by communication using a wireless LAN, specifically by Wi-Fi® communications technology.

The network repeater 30 includes a network repeater's communication device 32 and a network repeater's controller 34. The network repeater's communication device 32 is allowed to connect to and communicate with the image forming apparatus 20 over the wireless LAN. Because of this, the network repeater's communication device 32 includes a wireless LAN interface (I/F).

The network repeater's communication device 32 transmits identification information identifying the network repeater 30 (arrow 1). Specifically, the identification information is transmitted within a service area of the wireless LAN of the network repeater 30. The identification information includes a service set identifier (SSID) of the network repeater 30. SSID functions as the name given to a wireless LAN signal transmitted from the network repeater 30. The network repeater's controller 34 controls and causes the network repeater's communication device 32 to transmit the identification information.

The image forming apparatus 20 includes a wireless communication tag 22 that allows users to use, an image forming apparatus's communication device 28, a writer 24, and an image forming apparatus's controller 26.

In the present embodiment, the wireless communication tag 22 is a near-field communication (NFC) tag. Examples other than the NFC tag may include a radio-frequency identification (RFID) tag.

The image forming apparatus's communication device 28 receives the identification information transmitted from the network repeater's communication device 32. The image forming apparatus's communication device 28 is allowed to connect to and communicate with other devices. As will be described in more detail below, the image forming apparatus's communication device 28 is configured to connect to the terminal 10 by communication using a wireless LAN, specifically by a Wi-Fi DIRECT® communications method. Wi-Fi DIRECT® is one of Wi-Fi communications modes and allows terminals 10 to connect directly to and communicate with each other without the network repeater 30.

The writer 24 writes the identification information received by the image forming apparatus's communication device 28 to the wireless communication tag 22. Specifically, the identification information is stored in an integrated circuit (IC) chip included in the wireless communication tag 22.

Here, wireless LANs generally provide several radio bands simultaneously to prevent interference or the like. A symbol is therefore added at the end of a common SSID, thereby making it possible to identify respective pieces of identification information on radio bands. For example, “_A” or the like is added at the end of SSID in the case of 2.4 GHz band (IEEE 802.11b/g/n), while “_G” or the like is added at the end of SSID in the case of 5 GHz band (IEEE 802.11ac/a). For example, the image forming apparatus's communication device 28 receives respective pieces of identification information on different radio bands. In this case, the writer 24 writes the respective pieces of identification information on all the different radio bands to the wireless communication tag 22.

Similarly, to prevent interference or the like, wireless LANs generally provide several channels for each of the radio bands. In this case as well, a symbol is added at the end of a common SSID, thereby making it possible to identify respective channels. For example, “_A-1” or the like is added at the end in the case of 1 ch of 2.4 GHz band, while “_A-2” or the like is added at the end in the case of 2 ch of 2.4 GHz band. For example, the image forming apparatus's communication device 28 receives respective pieces of identification information on different channels. In this case, the writer 24 writes the respective pieces of identification information on all the different channels to the wireless communication tag 22.

The image forming apparatus's controller 26 controls respective processes of units in the image forming apparatus 20. Here, respective pieces of identification information on different radio bands or different channels as described above may be included in pieces of identification information received by the image forming apparatus's communication device 28. In this case, the image forming apparatus's controller 26 may be configured to control the order in which the writer 24 writes the pieces of identification information received to the wireless communication tag 22.

Specifically, a rule is determined in advance as to the order in which each frequency band's identification information or each channel's identification information is written to the wireless communication tag 22. The image forming apparatus's controller 26 controls the writer 24 to write each piece of identification information to the wireless communication tag 22 according to the rule determined.

The terminal 10 includes a reader 11, a display device 12, an input device 13, a transmitter 14, a terminal's communication device 16, a terminal's controller 15, and storage 17.

The reader 11 reads identification information from the wireless communication tag 22 (arrow 2). Specifically, the reader 11 uses near-field communication technology to read identification information written to the wireless communication tag 22. More specifically, the terminal 10 (with NFC-compatible I/F) is brought close to the wireless communication tag 22 (NFC tag) to generate an induced current between both of them. The induced current enables mutual communication, so that the identification information stored in the IC chip of the wireless communication tag 22 is read. Note that the reader 11 reads all the respective pieces of identification information on the different radio bands and the different channels, described above.

The display device 12 presents the respective pieces of identification information read by the reader 11. In the present embodiment, the terminal 10 is a smartphone. The display device 12 is typically a display (touch panel). The display device 12 also functions as an input device and allows users to operate while touching with his or her finger. The display device 12 presents each piece of identification information in a user-selectable manner. For example, in the presence of pieces of identification information, the display device 12 presents a list of the pieces of identification information for a user to select from. Note that the display device 12 presents all the respective pieces of identification information on the different radio bands and the different channels, described above. In this case, the display device 12 may be configured to present each piece of identification information in the order in which the writer 24 of the image forming apparatus 20 writes each piece of identification information to the wireless communication tag 22.

The input device 13 allows users to enter an encryption key through. The encryption key is information associated with identification information and required for connection with the network repeater 30.

The input device 13 is typically a display (touch panel) that also serves as the display device 12. The input device 13 allows users to enter, therethrough, an encryption key associated with identification information. The encryption key is set on the network repeater 30 side as a security measure in the connection between the image forming apparatus 20 and the network repeater 30.

The terminal's communication device 16 allows the terminal 10 and the image forming apparatus 20 to connect to and communicate with each other wirelessly. Specifically, the terminal's communication device 16 performs wireless communication by Wi-Fi DIRECT® communications method described above. Note that the terminal's communication device 16 may use other wireless communication methods such as Bluetooth®.

The transmitter 14 transmits identification information and an encryption key to image forming apparatus 20. Here, the identification information is identification information selected by a user from one or more pieces of identification information presented on the display device 12. The encryption key is an encryption key entered by the user. Specifically, the user selects identification information of the network repeater 30 that the user wishes to connect with the image forming apparatus 20, from each piece of identification information presented on the display device 12 in a selectable manner. The user then enters an encryption key associated with the identification information selected through the input device 13. The transmitter 14 transmits the encryption key entered to the image forming apparatus 20 through the terminal's communication device 16 (arrow 3)

The identification information and the encryption key are transmitted to the network repeater 30 through the terminal's communication device 16 from the transmitter 14 of the terminal 10, thereby enabling the image forming apparatus 20 to connect to and communicate with the network repeater 30 (arrow 4).

As described above, the network repeater's communication device 32 transmits identification information identifying the network repeater 30 (arrow 1).

The writer 24 writes the identification information transmitted by the network repeater 30 to the wireless communication tag 22.

The reader 11 reads identification information from the wireless communication tag 22 (arrow 2). The display device 12 presents one or more pieces of identification information read. A user selects identification information of the network repeater 30 to be connected to the image forming apparatus 20, from identification information presented on the display device 12. The user also enters an encryption key associated with the identification information through the input device 13.

The terminal's communication device 16 enables the terminal 10 to connect to and communicate with the image forming apparatus 20 (arrow 3). The transmitter 14 transmits the identification information selected by the user and the encryption key entered by the user to the image forming apparatus 20 (arrow 3). The image forming apparatus 20 configures the connection with the network repeater 30 using the identification information and encryption key transmitted (arrow 4).

In the image forming system 100 according to the present embodiment, writing to the wireless communication tag 22 is performed by the image forming apparatus 20. Information written is then read by the terminal 10. Information required to configure the connection is then transmitted with the terminal 10 allowed to connect to and communicate with the image forming apparatus 20. This approach enables the image forming apparatus 20 to connect to the network repeater 30 by using the terminal 10 even in the configuration in which the wireless communication tag 22 is prohibited from writing from outside the image forming apparatus 20.

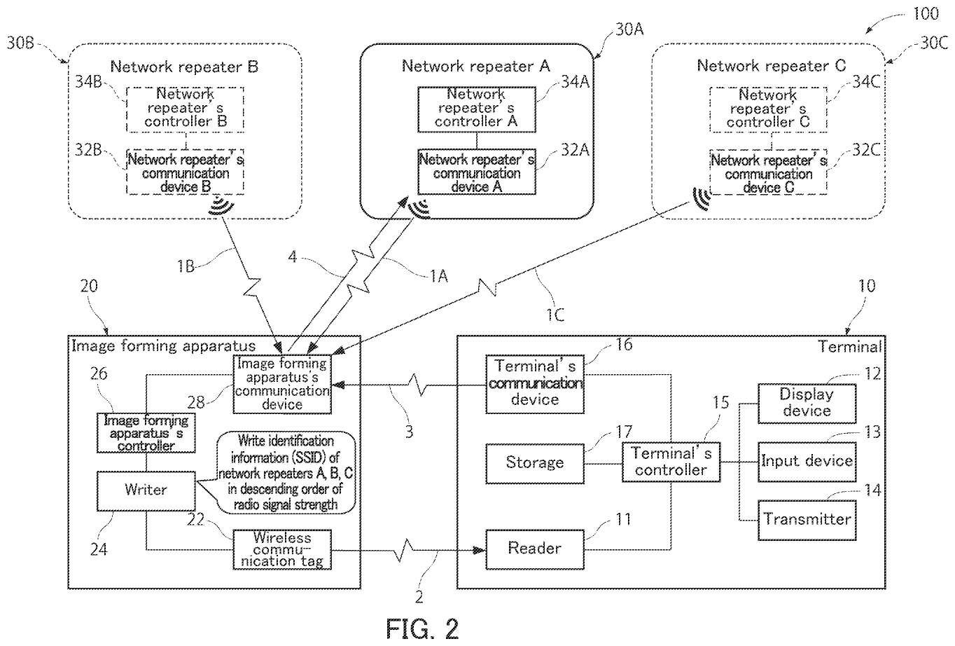

A configuration of an image forming system 100 in the presence of a plurality of network repeaters 30 will now be described with reference to FIG. 2.

In FIG. 2, three network repeaters 30 exist. Network repeaters 30A, 30B, and 30C include network repeater's communication devices 32A, 32B, and 32C, respectively. The network repeater's communication devices 32A, 32B, and 32C transmit different pieces of identification information using radio waves of the wireless LAN (arrows 1A, 1B, and 1C).

An image forming apparatus's communication device 28 receives respective pieces of identification information transmitted from the network repeater's communication devices 32A, 32B, and 32C. An image forming apparatus's controller 26 acquires the identification information while acquiring information on radio signal strength transmitted from each network repeater 30 in the wireless LAN, from the image forming apparatus's communication device 28. The image forming apparatus's controller 26 ranks each piece of identification information in descending order of radio signal strength.

The image forming apparatus's controller 26 then causes a writer 24 to write each piece of identification information of the network repeaters to a wireless communication tag 22 in descending order of radio signal strength.

That is, in the presence of connectable network repeaters 30, the writer 24 writes each piece of identification information of the network repeaters 30 to the wireless communication tag 22 in descending order of radio signal strength from each network repeater 30.

A reader 11 of a terminal 10 reads each piece of identification information written to the wireless communication tag 22. A terminal's controller 15 causes a display device 12 of the terminal 10 to present each piece of identification information read by the reader 11 in the order in which the writer 24 of the image forming apparatus 20 has written to the wireless communication tag 22.

That is, the display device 12 presents each piece of identification information in the order in which each piece of identification information has been written to the wireless communication tag.

In the present embodiment, the terminal 10 of the image forming system 100 presents respective pieces of identification information of the network repeaters 30A, 30B, and 30C in the descending order of radio signal strength. This approach enables users to easily select a network repeater 30 with strong radio signal strength.

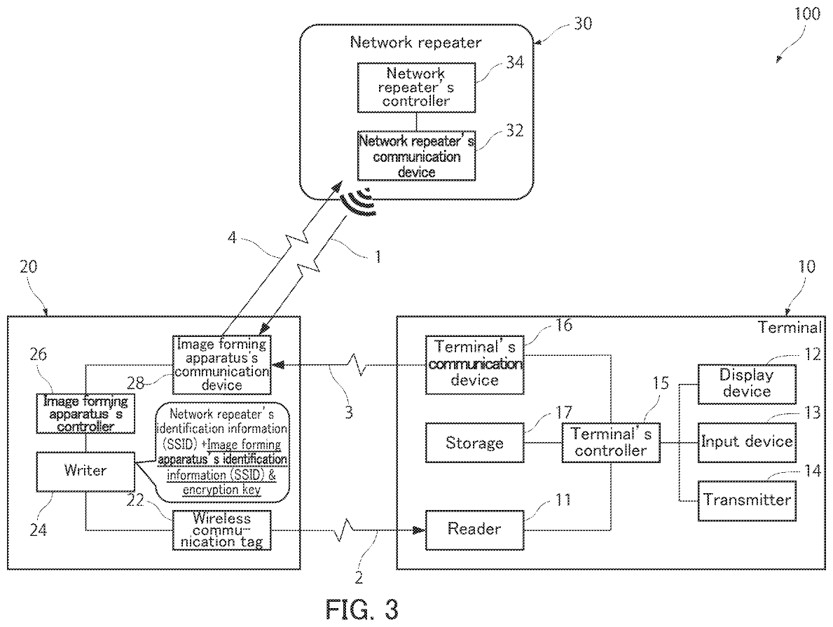

A configuration for easily configuring the communication between a terminal 10 and an image forming apparatus 20 will now be described with reference to FIG. 3. FIG. 3 is a schematic block diagram that depicts the configuration of an image forming system 100 that allows users to easily configure the communication between the terminal 10 and the image forming apparatus 20 on the terminal 10 side.

Here, the communication method between the terminal 10 and the image forming apparatus 20 is a Wi-Fi DIRECT® communications method. The image forming apparatus 20 is a device compatible with the Wi-Fi DIRECT® communications method. In the case of the communication using the Wi-Fi DIRECT® communications method, if one device supports the Wi-Fi DIRECT® communications method, the other device can communicate with the one device via a normal Wi-Fi communication I/F.

Allowing the terminal 10, from this side, to connect to and communicate with the image forming apparatus 20 by the Wi-Fi DIRECT® communications requires transmitting authentication information for the image forming apparatus 20 from the terminal 10 to the image forming apparatus 20.

In the image forming system 100 of FIG. 3, a writer 24 of the image forming apparatus 20 writes the authentication information for the image forming apparatus 20 to a wireless communication tag 22. Here, the authentication information includes image forming apparatus's identification information for identifying the image forming apparatus 20 and an image forming apparatus's encryption key required for the connection with the image forming apparatus 20.

A reader 11 of the terminal 10 then reads the image forming apparatus's identification information and the image forming apparatus's encryption key (arrow 2).

A terminal's communication device 16 connects the terminal 10 to the image forming apparatus 20 with the communication therebetween allowed by the Wi-Fi DIRECT® communications, based on the image forming apparatus's identification information and encryption key read by the reader 11 (arrow 3).

In the image forming system 100 according to the present embodiment, users do not have to enter the authentication information for the image forming apparatus 20 on the terminal 10 side. This approach enables the terminal 10 to easily connect to and communicate with the image forming apparatus 20.

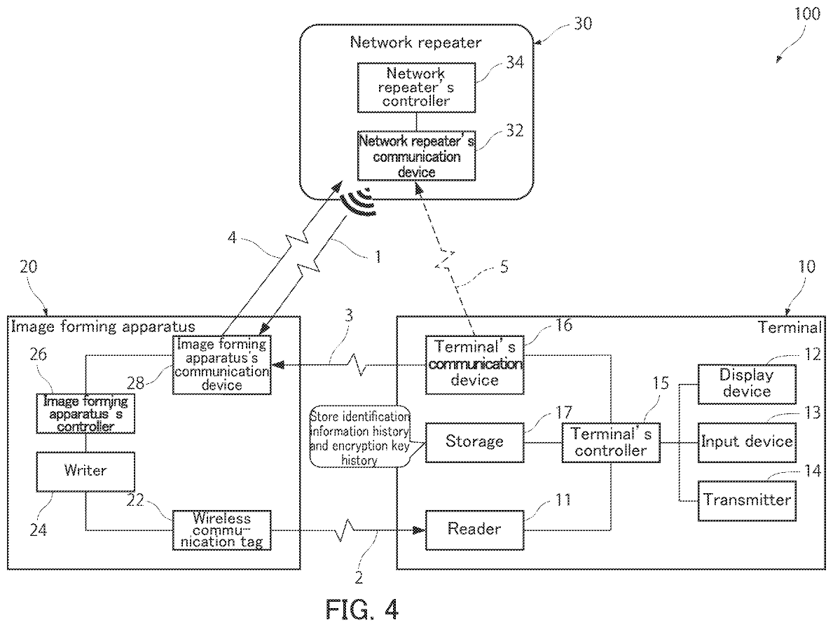

A configuration for omitting entry of an encryption key in a terminal 10 will now be described with reference to FIG. 4. FIG. 4 is a schematic block diagram that depicts the configuration of an image forming system 100 in the presence of a history of connections with the terminal 10 made in the past by a network repeater 30.

The image forming system 100 of FIG. 4 allows the terminal 10 to connect to and communicate with the network repeater 30. In FIG. 4, the network repeater 30 that allows users to use is each network repeater 30 that corresponds to the history of connections with the terminal 10 made in the past by. (dashed arrow 5) The terminal 10 of FIG. 4 stores an identification information history in the storage 17. The identification information history includes respective pieces of identification information of network repeaters 30 in the history of connections with the terminal 10 in the past. The terminal 10 also stores an encryption key history associated with the identification information history in the storage 17.

That is, the storage 17 is allowed to connect to and communicate with network repeaters 30. The storage 17 stores the identification information history about network repeaters 30 in a history, which the terminal 10 includes, of connections made in the past by the terminal 10 and the encryption key history associated with the identification information history.

A terminal's controller 15 checks whether or not the identification information of a network repeater 30 selected by a user is present in the identification information history. When the identification information of the network repeater 30 selected by the user is present in the identification information history, a transmitter 14 of the terminal 10 extracts and transmits an encryption key associated with the identification information selected, from the encryption key history, to an image forming apparatus 20 through a terminal's communication device 16 (arrow 3). The image forming apparatus 20 uses the encryption key received to connect with the network repeater 30 (arrow 4).

That is, when the identification information selected by the user is present in the identification information history, the transmitter 14 extracts the encryption key associated with the identification information selected, from the encryption key history and transmits the encryption key extracted to the image forming apparatus 20.

In the present embodiment, the image forming system 100 eliminates the need for users to enter encryption keys into the terminal 10. This approach enables users to easily connect the image forming apparatus 20 to a network.

### Process Flow of Image Forming System

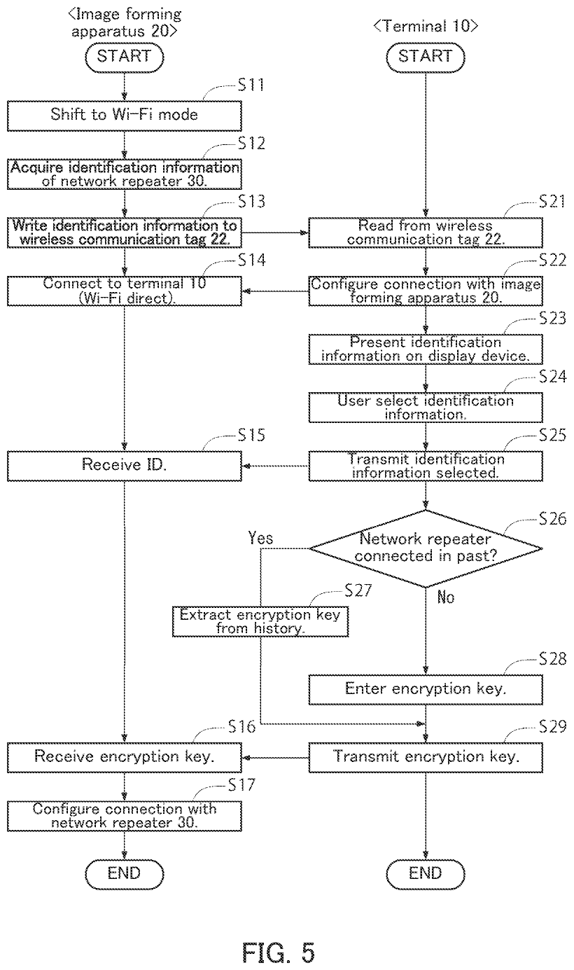

A network configuration method performed by an image forming system 100 will now be described with reference to FIG. 5. FIG. 5 is a flow chart that depicts an overall process of the image forming system 100.

An image forming apparatus 20 first shifts a network connection mode to a Wi-Fi connection-only mode (Step S11). That is, the image forming apparatus 20 enables an I/F for a wireless LAN.

The image forming apparatus 20 then receives the identification information of a network repeater 30 transmitted from the network repeater 30. Specifically, SSID is received as the identification information by the image forming apparatus 20 (Step S12). Note that in the presence of a plurality of network repeaters 30, the image forming apparatus 20 may be configured to receive respective pieces of identification information transmitted by the network repeaters 30.

The image forming apparatus 20 writes network repeater's 30 identification information received to a wireless communication tag 22 (Step S13). Note that in the presence of a plurality of network repeaters 30, the image forming apparatus 20 may be configured to write respective pieces of identification information of the network repeaters 30 to the wireless communication tag 22 in descending order of signal strength acquired from each of the network repeaters 30.

Assumed that a Wi-Fi DIRECT® connection between the image forming apparatus 20 and a terminal 10 is carried out with the image forming apparatus 20 being as a master device. In this case, the image forming apparatus 20 may be configured to further write image forming apparatus's identification information and encryption key to the wireless communication tag 22.

The terminal 10 reads identification information written to the wireless communication tag 22 (Step S21). The terminal 10 configures a Wi-Fi DIRECT® connection, thereby enabling the communication between the terminal 10 and the image forming apparatus 20 (Steps S22 and S14).

At this time, assumed that the image forming apparatus's identification information and encryption key have been written to the wireless communication tag 22. In this case, the terminal 10 may be configured to automatically configure a Wi-Fi DIRECT® connection between the terminal 10 and the image forming apparatus 20 based on the image forming apparatus's identification information and encryption key read.

The terminal 10 presents identification information read on a display device 12 of the terminal 10 (Step S23). At this time, assumed that the terminal 10 reads respective pieces of identification information of network repeaters 30. In this case, the terminal 10 may be configured to present the respective pieces of identification information read on the display device 12 in the order in which the respective pieces of identification information have been read.

A user selects identification information of a network repeater 30 to be used for a connection between the image forming apparatus 20 and the network repeater 30 from the identification information of each network repeater 30 presented on the terminal 10.

The terminal 10 transmits network repeater's 30 identification information selected by the user to the image forming apparatus 20 (Step S25). The image forming apparatus 20 receives the network repeater's 30 identification information (Step S15).

Here, a terminal 10 is allowed to connect to a network repeater 30. The terminal 10 also stores therein an identification information history of network repeaters 30 connected therewith in the past and an encryption key history associated with the identification information history.

A user selects a network repeater 30 in the history connected with the terminal 10 in the past (Yes in Step S26). In this case, the terminal 10 extracts an encryption key associated with identification information selected by the user, from the encryption key history stored in the terminal 10. The terminal 10 then transmits the encryption key extracted to the image forming apparatus 20 (Step S29). A process of the terminal 10 then ends (END). The image forming apparatus 20 receives the encryption key transmitted (Step S16).

A user selects no network repeater 30 in the history connected with the terminal 10 in the past (No in Step S26). In this case, the user enters an encryption key associated with the identification information selected by the user into the terminal 10 (Step S28). The terminal 10 transmits the encryption key entered to the image forming apparatus 20 (Step S29). The image forming apparatus 20 receives the encryption key transmitted (Step S16).

The image forming apparatus 20 configures the connection with the network repeater 30 based on network repeater's 30 identification information and encryption key received (Step S17). A process of the image forming apparatus 20 then ends (END).

In an image forming system 100 as described above, a network repeater 30 transmits identification information identifying the network repeater 30. An image forming apparatus 20 writes the identification information transmitted to a wireless communication tag 22. A terminal 10 reads the identification information from the wireless communication tag 22. The terminal 10 also presents the identification information read.

The terminal further transmits identification information and an encryption key to the image forming apparatus 20. Here, the identification information is identification information selected by a user from one or more pieces of identification information presented. The encryption key is an encryption key entered by the user and is required for connection with the network repeater 30. The image forming apparatus 20 then configures the connection with the network repeater 30 based on the identification information and the encryption key received from the terminal 10.

According to a method implemented in an image forming system 100 as described above, writing to a wireless communication tag 22 is performed by an image forming apparatus 20. Information written is then read by a terminal 10. Information required for connection configuration is then transmitted with the terminal 10 allowed to connect to and communicate with the image forming apparatus 20. It is therefore possible to connect the image forming apparatus 20 to a network repeater 30 by using the terminal 10 even in configuration where the wireless communication tag 22 prohibits writing from outside the image forming apparatus 20.

The embodiments of the present disclosure have been described above with reference to the accompanying drawings. However, the present disclosure is not limited to the above embodiments. The present disclosure may be implemented in various manners within a scope not departing from the essence thereof. The drawings illustrate each constituent element mainly in a schematic manner to facilitate understanding of the present disclosure. Aspects such as the thickness, length, number, and interval of each constituent element illustrated in the drawings may differ in practice for convenience of drawing preparation. Further, the material, shape, or dimensions of each constituent element or the like described in the above embodiments is merely an example that does not impose any particular limitations and may be altered in various ways as long as such alterations do not substantially deviate from the effects of the present disclosure.

What is claimed is:

1. An image forming system comprising:
a terminal that allows a user to use;
an image forming apparatus that allows the user to use, the image forming apparatus including a wireless communication tag; and
a network repeater that allows the image forming apparatus to connect to and communicate over a network, wherein
the network repeater includes a network repeater's communication device that transmits identification information identifying the network repeater,
the image forming apparatus includes a writer that writes the identification information received to the wireless communication tag,
the terminal includes
a reader that reads the identification information from the wireless communication tag,
a display device that presents the identification information read by the reader,
a terminal's communication device that is allowed to connect to and communicate with the image forming apparatus,
an input device that receives an encryption key that is information associated with the identification information and required for connection with the network repeater, and
a transmitter that transmits, to the image forming apparatus, the identification information selected by the user from one or more pieces of identification information presented on the display device and the encryption key entered by the user, and
the image forming apparatus configures a connection with the network repeater based on the identification information and the encryption key transmitted from the transmitter of the terminal.

2. The image forming system according to claim 1, wherein
in a connectable state with a plurality of network repeaters each of which corresponds to the network repeater, the writer writes respective pieces of identification information of the plurality of network repeaters to the wireless communication tag in descending order of signal strength of each network repeater, and
the display device presents the identification information in order in which the respective pieces of identification information have been written to the wireless communication tag.

3. The image forming system according to claim 2, wherein
the writer further writes, to the wireless communication tag, image forming apparatus's identification information identifying the image forming apparatus and an image forming apparatus's encryption key that is required for connection with the image forming apparatus, and
the reader further reads the image forming apparatus's identification information and the image forming apparatus's encryption key, and
the terminal's communication device causes the terminal to connect to and communicate with the image forming apparatus based on the image forming apparatus's identification information and the image forming apparatus's encryption key.

4. The image forming system according to claim 1, wherein
the terminal is allowed to connect to and communicate with the network repeater,
the terminal further including storage that stores an identification information history about the network repeater in a history, which the terminal includes, of previous connections made by the terminal and an encryption key history associated with the identification information history, and
the transmitter extracts the encryption key associated with the identification information selected by the user from the encryption key history and transmits the encryption key extracted to the image forming apparatus when the identification information history includes the identification information selected by the user.

5. An image forming method comprising:
transmitting identification information identifying a network repeater;
writing the identification information transmitted to a wireless communication tag
reading the identification information from the wireless communication tag;
presenting the identification information read;
transmitting, to an image forming apparatus, identification information selected by a user from one or more pieces of identification information presented and an encryption key that is required for connection with the network repeater and entered by the user; and
configuring a connection with the network repeater based on the identification information and the encryption key transmitted through a terminal.
